(19) United States
(12) Patent Application Publication
(10) Pub. No.: US 2019/0072434 A1
(43) Pub. Date: Mar. 7, 2019

(54) High Temperature Soil Probe

(71) Applicant: The United States of America as Represented by the Secretary of Agriculture, Washington, DC (US)

(72) Inventors: Peter Robichaud, Moscow, ID (US); Robert E. Brown, Palouse, WA (US)

(21) Appl. No.: 16/120,783

(22) Filed: Sep. 4, 2018

Related U.S. Application Data
(60) Provisional application No. 62/554,156, filed on Sep. 5, 2017.

(51) Int. Cl. G01K 1/12; G01K 13/00; G01K 1/02; G01K 7/02

(52) U.S. Cl. CPC G01K 1/12; G01K 7/02; G01K 1/022; G01K 13/00

(57) ABSTRACT

A soil temperature probe that can withstand the extremely high temperatures produced by wildfires is provided. Also provided are methods for using the probe to measure the temperature profile in the soil when a fire passes over the soil or when a fire burns in place over the soil. The device is designed for use during wildfires, prescribed fires, and/or slash pile burning to measure high temperatures in incremental temperature measurements at multiple precise depths to generate a soil temperature profile.

### CROSS-REFERENCE TO RELATED APPLICATIONS

The present application claims priority to U.S. provisional patent application No. 62/554,156 that was filed Sep. 5, 2017, the entire contents of which are hereby incorporated by reference.

### BACKGROUND

Soil is a valuable non-renewable resource. When soil is exposed to the high temperatures produced by wildfires and prescribed fires, the heat affects soil properties such that soil can become water repellent, viable seed sources can be killed, and fine roots can be consumed, which in turn negatively impacts the recovery rate of the vegetation. With the current climate change trends and increase in wildfires, it is important to understand the biological, physical, and chemical effects fires have on soil, in order to sustain soil resources, and aid in the post-fire recovery of ecosystems.

### SUMMARY

A soil temperature probe that can withstand the extremely high temperatures produced by wildfires is provided. Also provided are methods for using the probe to measure the temperature profile in the soil when a fire passes over the soil or when a fire burns in place over the soil.

One embodiment of a soil temperature probe includes: (a) a housing that defines a cavity, the housing having a plurality of openings defined at different depths along its side; (b) a thermocouple rack comprising a plurality of thermocouples, each thermocouple being disposed in a thermocouple sleeve having a leading end, wherein the thermocouple sleeves are positioned at different depths within the housing and aligned with the openings in the side of the housing; and (c) a thermocouple data logger in communication with the thermocouples, the thermocouple data logger comprising software that is configured to record voltage signals from the thermocouples and to correlate the voltage signals into temperature data.

One embodiment of a method of obtaining a soil temperature profile using the soil temperature probe includes: (a) inserting the probe into the soil such that all of the thermocouples are at a depth below a surface of the soil; (b) moving the leading ends of the thermocouple sleeves through the openings and into the soil; (c) measuring and recording soil temperatures at different depths below the surface of the soil using the thermocouples and the thermocouple data logger; and (d) generating a soil temperature profile from the measured soil temperatures.

Other principal features and advantages of the invention will become apparent to those skilled in the art upon review of the following drawings, the detailed description, and the appended claims.

### BRIEF DESCRIPTION OF THE DRAWINGS

Illustrative embodiments of the invention will hereafter be described with reference to the accompanying drawings, wherein like numerals denote like elements.

FIG. 1A shows an embodiment of a high temperature soil probe, including a housing and sub-housing.

FIG. 1B shows the high temperature soil probe of FIG. 1A without the housing and sub-housing.

FIG. 1C shows the thermocouple rack for the high temperature soil probe of FIG. 1A.

### DETAILED DESCRIPTION

A soil temperature probe that can withstand the extremely high temperatures produced by wildfires and other fires (referred to herein as a High Temperature Soil Probe) is provided. The probe is characterized in that it remains operational even under extreme temperature conditions. For example, embodiments of the probe are able to withstand temperatures of 800° C. or higher, including temperatures of 1000° C. or higher. Also provided are methods for using the probe to measure the temperature profile in the soil when a fire passes over the soil or when a fire burns in place over the soil. The probe is designed for use during wildfires, prescribed fires, and/or slash pile burning to measure high temperatures in incremental temperature measurements at multiple precise depths to generate a soil temperature profile.

Typically, temperatures will be measured at soil depths of up to 10 cm from the soil surface. However, for long-burning stationary fires, such as slash pile fires, which can heat the soil to greater depths, soil temperatures can be measured at greater depths. For example, some embodiments of the high temperature soil probe measure soil temperatures down to a depth of 20 cm or more.

The High Temperature Soil Probe is a self-contained device that enables the study of the below-ground effects of fire and high temperatures on soil. The soil temperature profile data generated by the device helps the user explore how temperatures produced by fires alter the chemical, biological, and/or physical properties of soil. Furthermore, the device can provide a foundation for the creation of below ground soil heating models. Using data collected from this device, the below-ground effects of fires can be predicted based on such factors as soil properties, ground cover, duff thickness, fuel loading, and fire weather. As such, the High Temperature Soil Probe is useful for a range of users such as land management agencies, research institutes, and consultants concerned with fire and soil effects.

The probe has three main components: a housing; a data acquisition device held within the housing; and multiple thermocouples and their deployment apparatus held within the housing.

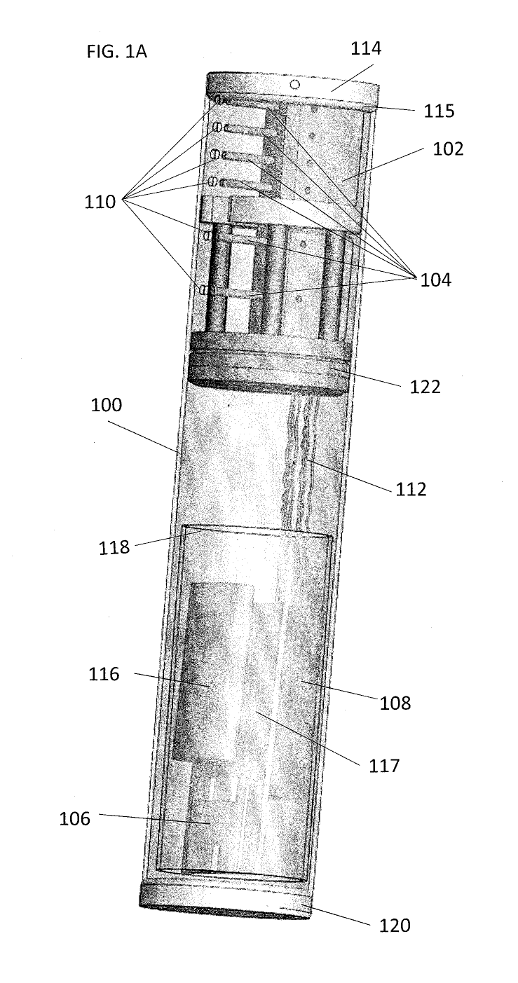

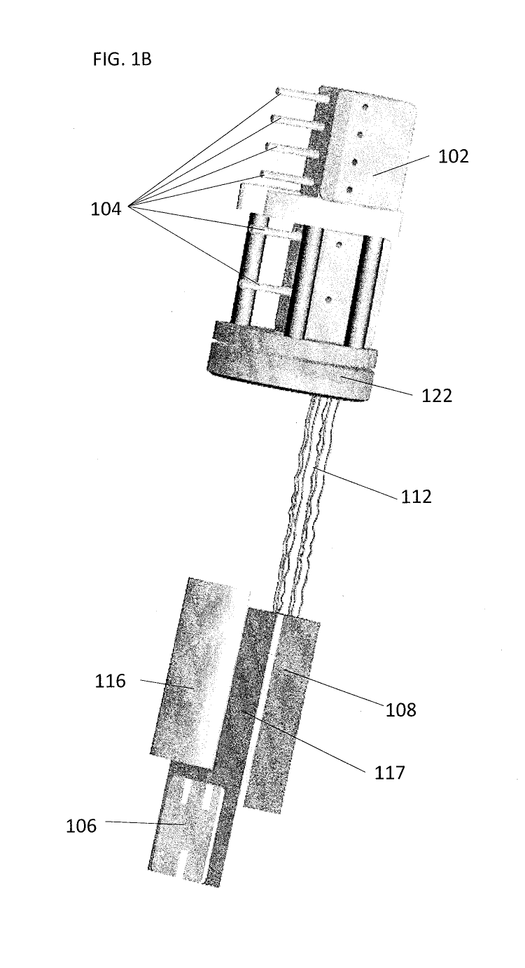

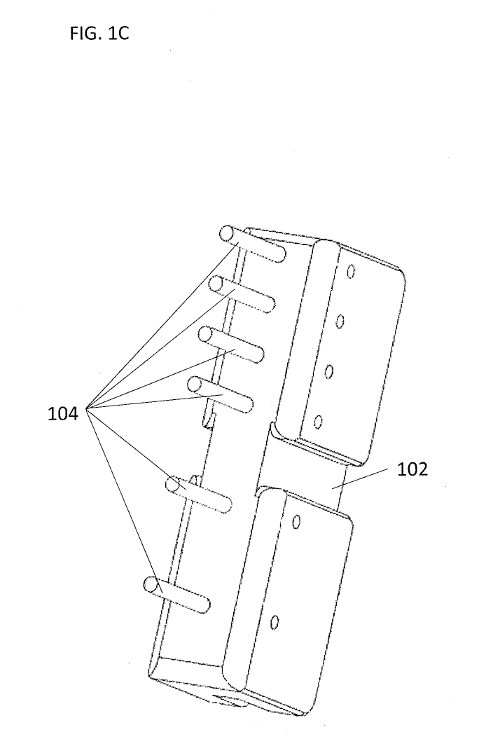

One illustrative embodiment of a soil temperature probe is shown in FIG. 1A, which includes the housing, and in FIG. 1B, which shows the device without the housing. The probe includes: (a) a housing 100 that defines a cavity; (b) a thermocouple rack 102 comprising a plurality of thermocouples, each thermocouple being disposed in a protective thermocouple sleeve 104, wherein the thermocouple sleeves are positioned at different depths within the housing; and (c); one or more thermocouple data loggers 108 in communication with the thermocouples.

Housing 100 has a plurality of openings 110 defined at different depths along its side and each thermocouple sleeve 104 is lined up with one of the openings 110 in the housing. Thermocouple rack 102 is configured such that the leading ends 112 of thermocouple sleeves 104 can be moved through openings 110 from a position inside of the housing to a position outside of the housing when the thermocouple rack slides forward. Thermocouple data logger 108 includes software that is configured to record voltage signals from the thermocouples and to correlate the voltage signals into temperature data. Thermocouple data logger 108 is powered by a power source, such as a battery 116. Data logger 108 can also include an interval timer that controls the time intervals at which the temperature data from the voltage signals are recorded. The interval timer can be programmed to record the temperature data at intervals for a time duration designed to provide useful information based on the expected duration of the heat pulse of the fire. By way of illustration only, soil temperature can be recorded at intervals in the range from 0.1 seconds to 60 seconds or greater over a period of one day, one week, or longer. However, shorter or longer time intervals and time periods can also be used.

Housing 100 is made of a high temperature resistant material, such as stainless steel. Although the housing shown in FIG. 1A is a straight cylinder with a circular cross-sectional profile, the housing could have other cross-sectional shapes, including, for example, square or triangular. Housing includes a removable top cap 114 that can be removed by a user to gain access to and slide the thermocouple rack 102. In order to protect the internal components of the probe from the heat produced by a fire on the surface of the soil, a thermally insulating tile 115, such as a ceramic tile, can be disposed just below top cap 114. The housing is sized to fit the internal components and any internal insulation layers. Typical lateral dimensions (i.e., the diameter) are in the range from about 4 cm to about 8 cm, although lateral dimensions outside of this range could be used. Typical housing heights are in the range from about 30 cm to 50 cm, although height dimensions outside of this range could be used.

Thermocouple rack 102 includes a plurality of thermocouples in their thermocouple sleeves 104 arranged longitudinally at different depths within the housing. The thermocouple sleeves can be, for example, stainless steel tubes surrounding the thermocouples. In some embodiments of the probe, thermocouple rack can simply be pushed forward by hand to move the leading ends of thermocouple sleeves 104 through holes 110 and into the surrounding soil when the probe is in place. A more detailed view of thermocouple rack is shown in FIG. 1C.

In other embodiments, a drive can be connected to thermocouple rack 102. The drive can be configured to move the leading ends of thermocouple sleeves 104 through openings 110 from a position inside of the housing to a position outside of the housing. A variety of linear actuators can be used as a drive. However, the linear actuator should be robust and should not require a clean environment for proper operation. One example of such a drive is a rack and pinon gear. Other drives that could be used include roller pinions and screw actuators.

The device uses high temperature thermocouples (for example, type K thermocouples; (range −200° C. to 1250° C., −330° F. to 2280° F.)). These high temperature thermocouples are able to measure the high soil temperatures generated by fire, including temperatures in the range from 500° C. to 800° C. In the embodiment shown in FIGS. 1A and 1B, six thermocouples are used and they are spaced in a line at depths of 1 cm, 2 cm, 3 cm, 4 cm, 6 cm, and 8 cm (0.4, 0.8, 1.2, 1.6, 2.4, 3.2 inches, respectively) from the top of the device housing. When exposed to heat from the soil, the thermocouples generate an output voltage that varies in a known manner (e.g., linearly) with temperature over the target temperature range. The output voltages are read by the thermocouple data loggers, which convert the signals into a soil temperature profile that shows how the soil temperature varies as a function of time and depth below the soil surface. This data is stored for later analysis.

Data loggers 108 are connected to the thermocouples via one or more electrical wires 112 and are part of a self-contained data acquisition system. Data loggers 108 generally include a processor, data storage (e.g., a computer-readable medium) 106, and one or more interval timers. The data loggers can be pre-programmed for data acquisition. They can be, but need not be, configured for remote operation. If they are configured for remote operation, they include a signal transmitter configured to communicate data wirelessly to a signal receiver on a remote device, such as a computer. Computer-readable medium 106 is an electronic holding place or storage for information so the information can be accessed by the processor as understood by those skilled in the art. The computer-readable medium can include, but is not limited to, any type of random access memory (RAM), any type of read only memory (ROM), any type of flash memory, etc. such as magnetic storage, optical disks, digital versatile disc (DVD), etc.), smart cards, flash memory devices, etc.

The processor executes instructions as understood by those skilled in the art. The instructions may be carried out by a special purpose computer, logic circuits, hardware circuits, or other methods. The processor may be implemented in hardware and/or firmware. The processor executes an instruction, meaning it performs/controls the operations called for by that instruction. The term “execution” is the process of running an application or the carrying out of the operation called for by an instruction. The instructions may be written using one or more programming language, scripting language, assembly language, etc. The processor can be operably coupled with the computer-readable medium and an output interface that is configured to receive, to send, to display, and/or to otherwise process the temperature data. For example, the temperature data points from each thermocouple can be graphed to create a soil temperature profile graph.

The data loggers can be supported by a data logger rack 117 which keeps them suspended above the floor of housing 100, which may be stoppered by an end cap 120. It is advantageous to position the data loggers toward the bottom of the housing in order to protect them from thermal damage caused by the heat of surface fire. In addition, the housing can be water-proofed and/or thermally insulated in the vicinity of the data loggers using an insulating sub-housing 118 that is internal to main housing 100. Additionally, a rubber seal 122 can be provided between the bottom of thermocouple rack 102 and the data acquisition system comprising thermocouple data loggers 108 and data storage 106 to provide additional insulation for the electronic components.

To use the soil temperature probe, a hole is dug in the soil using, for example, a piece of steel tubing to remove a soil core. The hole should be large enough to fully insert the soil temperature probe, such that the top of housing 100 is flush, or substantially flush, with the soil surface, but not so large that the thermocouples and their sleeves 104 will not be inserted into the soil when they are pushed out of the housing through holes 110. Once the probe is installed in the soil, the thermocouples can be manually deployed by a user who forces thermocouple sleeves 104 into the surrounding soil—either directly by hand or by engaging a drive. Soil temperature data can then be collected as a fire passes over the soil temperature probe and/or as a fire burns in a stationary position over the soil temperature probe.

The High Temperature Soil Probe is reusable, and its innovative design allows for safe and easy deployment, recovery, and data acquisition. It can be deployed with just one person in under fifteen minutes. This is important because it is potentially hazardous for the personnel to spend a long time on the fire front during wildfires, or an extended time before a prescribed fire. Once the fire passes over the High Temperature Soil Probe, the device can be retrieved by one person in minutes by simply removing it from the soil. Soil temperature profile data from the data loggers can be uploaded to a computer using connector, such as an auxiliary to USB cable. Commercial software on the computer can then automatically download and graph or otherwise store, manipulate, and/or display the data points.

The word “illustrative” is used herein to mean serving as an example, instance, or illustration. Any aspect or design described herein as “illustrative” is not necessarily to be construed as preferred or advantageous over other aspects or designs. Further, for the purposes of this disclosure and unless otherwise specified, “a” or “an” means “one or more.”

The foregoing description of illustrative embodiments of the invention has been presented for purposes of illustration and of description. It is not intended to be exhaustive or to limit the invention to the precise form disclosed, and modifications and variations are possible in light of the above teachings or may be acquired from practice of the invention. The embodiments were chosen and described in order to explain the principles of the invention and as practical applications of the invention to enable one skilled in the art to utilize the invention in various embodiments and with various modifications as suited to the particular use contemplated. It is intended that the scope of the invention be defined by the claims appended hereto and their equivalents.

What is claimed is:

1. A soil temperature probe comprising:
a housing that defines a cavity, the housing having a plurality of openings defined at different depths along its side;
a thermocouple rack comprising a plurality of thermocouples, each thermocouple being disposed in a thermocouple sleeve having a leading end, wherein the thermocouple sleeves are positioned at different depths within the housing and aligned with the openings in the side of the housing; and
a thermocouple data logger in communication with the thermocouples, the thermocouple data logger comprising software that is configured to record voltage signals from the thermocouples and to correlate the voltage signals into temperature data.

2. The probe of claim 1, wherein the thermocouple sleeves are disposed at depths in the range from 0.1 cm to 10 cm, as measured from the top of the housing.

3. The probe of claim 2, wherein the thermocouple sleeves are spaced apart by distances in the range from 0.5 cm to 2.5 cm.

4. The probe of claim 1, further comprising a drive configured to move the leading ends of the thermocouple sleeves from a position inside of the housing to a position outside of the housing.

5. The probe of claim 1, wherein the data logger further comprises an interval timer that controls the time intervals at which the temperature data from the voltage signals are recorded.

6. The probe of claim 1, wherein the probe is able to withstand soil surface temperatures of at least 800° C. without becoming inoperational.

7. The probe of claim 1, wherein the probe is able to withstand soil surface temperatures of at least 1000° C. without becoming inoperational.

8. A method of obtaining a soil temperature profile using the probe of claim 1, the method comprising:
inserting the probe into the soil such that all of the thermocouples are at a depth below a surface of the soil;
moving the leading ends of the thermocouple sleeves through the openings and into the soil;
measuring and recording soil temperatures at different depths below the surface of the soil using the thermocouples and the thermocouple data logger; and
generating a soil temperature profile from the measured soil temperatures.

9. The method of claim 8, wherein the soil temperatures are measured at a plurality of time intervals before, during, and after a fire passes over the surface of the soil.

10. The method of claim 8, wherein the soil temperatures are measured at a plurality of time intervals while a stationary fire burns on the surface of the soil.

11. The method of claim 8, wherein the soil temperatures are measured at time intervals in the range from 0.1 seconds to 60 seconds over a period of at least one day.

12. The method of claim 8, wherein the measured soil temperatures include temperatures of 500° C. or higher.
